(19) United States
(12) Patent Application Publication
(10) Pub. No.: US 2009/0234511 A1
(43) Pub. Date: Sep. 17, 2009

(54) DEMAND CONTROL DEVICE

(75) Inventors: Atsushi Ouchi, Takatsuki City (JP); Hideki Nakajima, Osaka City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi City, Osaka (JP)

(21) Appl. No.: 12/306,133

(22) PCT Filed: Jun. 13, 2007
(86) PCT No.: PCT/JP2007/062371

§ 371 Date: Dec. 22, 2008

(30) Foreign Application Priority Data
Jun. 28, 2006 (JP) 2006-178043

(51) Int. Cl. G06F 1/26

(52) U.S. Cl. 700/291; 700/296

(57) ABSTRACT

A demand control device includes a predicted value calculating unit (21) arranged to calculate a predicted value of a power consumption integrated value for each one of a plurality of demand time intervals including a current demand time interval and a predetermined number of demand time intervals subsequent to the current demand time interval based on performance data stored in a power database (24) at the start of the demand time interval, and a control unit (21) arranged to control appliances based on the predicted value calculated by the predicted value calculating unit (21) for each one of the plurality of demand time intervals and on a pre-set target value.

### TECHNICAL FIELD

The present invention relates to a demand control device which predicts a power consumption integrated value in a demand time interval, and controls appliances based on a predicted value.

### BACKGROUND ART

A demand-based contract system is available as a contract system for electricity rates, which is implemented between a store/facility owner and an electric power company. The demand-based contract system determines electricity rates based on the maximum integrated value of electric power consumed in demand time intervals in a year. In this system, a power consumption integrated value is calculated for each one of the predetermined demand time intervals, and the electricity rates are determined based on the maximum of the power consumption integrated values calculated for the respective demand time interval in a year. The demand time interval is a time period value such as 15 minutes or 30 minutes, or a time zone between 12:00 and 2:00 in which electric power consumption increases. Therefore, it is necessary to minimize the power consumption integrated value in one demand time interval.

To meet the necessity, a control (demand control) operation is performed which predicts a power consumption integrated value from the start of a demand time interval to the end thereof during the demand time interval, and halts the operation of a specified appliance when the predicted value exceeds the predetermined contract power amount.

Typical demand control is effected by predicting, for each one of demand time intervals, a power consumption integrated value only within the demand time interval, and performing a demand control operation in the demand time interval based on the predicted value. Therefore, in the case where the predicted value for the demand time interval is considerably larger than a target value, a method of operating appliances should be significantly changed compared with the case where the predicted value for the demand time interval is not more than the target value. In some cases, it is impossible to reduce the power consumption integrated value within the demand time interval to a value not more than the target value.

In the paragraph numbered [0014] in the publication of Japanese Patent No. 2913584, it is disclosed to measure and record a demand value (the maximum of the mean values of electric power amounts which are averaged every 30 minutes), outside air temperature data, and humidity data obtained at an air-cooled place, perform learning calculations to predict a demand control issue time and a demand control duration, calculate an excessive cooling set temperature, an excessive cooling required period, and an excessive cooling start time, and control an air conditioner based on the results of the calculations. However, it is unknown how to predict the demand control issue time and the demand control duration based on the demand value, the outside air temperature data, and the humidity data obtained at the air-cooled place. It is also unknown how to calculate the excessive cooling set temperature, the excessive cooling required period, and the excessive cooling start time.

An object of the present invention to provide a demand control device which calculates a predicted value of a power consumption integrated value for each one of a plurality of demand time intervals including a current demand time interval and a predetermined number of demand time intervals subsequent to the current demand time interval to allow, when the predicted value exceeds a target value in any of the demand time intervals, a reduction in power consumption integrated value in the foregoing demand time interval in which the predicted value exceeds the target value through effective use of another demand time interval in which the predicted value has a margin.

### DISCLOSURE OF THE INVENTION

A demand control device according to a first aspect of the present invention is a demand control device applied in a facility provided with a plurality of power-consuming appliances, the demand control device including a unit arranged to store performance data of a power consumption integrated value for each individual environmental condition in a power database, a predicted value calculating unit arranged to calculate a predicted value of the power consumption integrated value for each one of a plurality of demand time intervals including a current demand time interval and a predetermined number of demand time intervals subsequent to the current demand time interval based on the performance data stored in the power database at a start of the demand time interval, and a control unit arranged to control the appliances based on the predicted value calculated by the predicted value calculating unit for each one of the plurality of demand time intervals and on a pre set target value, wherein the control unit includes a unit arranged to change, when the plurality of demand time intervals include the demand time interval in which the predicted value exceeds the target value and the demand time intervals in each of which the predicted value does not exceed the target value, and operation contents each scheduled in the demand time interval in which the predicted value exceeds the target value include the operation content whose operation time is changeable, the changeable operation time of the operation content such that the operation content whose operation time is changeable is executed in any of the demand time intervals in each of which the predicted value does not exceed the target value.

In the demand control device according to the first inventive aspect, the operation content whose operation time is, e.g., a defrosting operation of a showcase.

In the demand control device according to the first inventive aspect, the control unit may include a unit arranged to select, when the predicted value calculated by the predicted value calculating unit for the current demand time interval exceeds the target value, any of the appliances whose operation should be halted based on a difference between the predicted value for the current demand time interval and the target value, and halt the operation of the selected appliance.

In the demand control device according to the first inventive aspect, the control unit may include a unit arranged to select, when the predicted value calculated by the predicted value calculating unit for the current demand time interval exceeds the target value, any of the appliances which should be halted based on a difference between the predicted value for the current demand time interval and the target value, and halt the selected appliance, and a unit arranged to select, when the predicted value calculated by the predicted value calculating unit for the current demand time interval is not more than the target value, any of the appliances whose operation should be recovered based on the difference between the predicted value for the current demand time interval and the target value, and recover the operation of the selected appliance.

A demand control device according to a second aspect of the present invention is a demand control device applied in a facility provided with a plurality of power-consuming appliances, the demand control device including a unit arranged to store performance data of a power consumption integrated value for each individual environmental condition in a power database, a predicted value calculating unit arranged to calculate a predicted value of the power consumption integrated value for each one of a current demand time interval and a demand time interval subsequent to the current demand time interval based on the performance data stored in the power database at a start of the demand time interval, and a control unit arranged to control the appliances based on the predicted value calculated by the predicted value calculating unit for each one of the plurality of demand time intervals and on a pre-set target value, wherein the control unit includes a unit arranged to control, when the predicted value for the current demand time interval does not exceed the target value, and the predicted value for the subsequent demand time interval exceeds the target value, an operation of at least one of the appliances which are continuously operated over the both demand time intervals such that an effect of operating the appliance is higher in the current demand time interval than during a normal operation.

In the demand control device according to the second inventive aspect, the appliance which is continuously operated over the both demand time intervals is, e.g., a temperature adjusting appliance. In this case, when the predicted value for the current demand time interval does not exceed the target value, and the predicted value for the subsequent demand time interval exceeds the target value, the control unit changes a set temperature of the temperature adjusting appliance such that an effect of operating the appliance is higher in the current demand time interval than during a normal operation.

In the demand control device according to the second inventive aspect, the control unit may include a unit arranged to select, when the predicted value calculated by the predicted value calculating unit for the current demand time interval exceeds the target value, any of the appliances whose operation should be halted based on a difference between the predicted value for the current demand time interval and the target value, and halt the operation of the selected appliance.

In the demand control device according to the second inventive aspect, the control unit may include a unit arranged to select, when the predicted value calculated by the predicted value calculating unit for the current demand time interval exceeds the target value, any of the appliances which should be halted based on a difference between the predicted value for the current demand time interval and the target value, and halt the selected appliance, and a unit arranged to select, when the predicted value calculated by the predicted value calculating unit for the current demand time interval is not more than the target value, any of the appliances whose operation should be recovered based on the difference between the predicted value for the current demand time interval and the target value, and recover the operation of the selected appliance.

A demand control device according to a third aspect of the present invention is a demand control device applied in a facility provided with a plurality of power-consuming appliances, the demand control device including a unit arranged to store performance data of a power consumption integrated value for each individual environmental condition in a power database, a predicted value calculating unit arranged to calculate a predicted value of the power consumption integrated value for each one of a plurality of demand time intervals including a current demand time interval and a predetermined number of demand time intervals subsequent to the current demand time interval based on the performance data stored in the power database at a start of the demand time interval, and a control unit arranged to control the appliances based on the predicted value calculated by the predicted value calculating unit for each one of the plurality of demand time intervals and on a pre-set target value, wherein the control unit includes a first unit arranged to change, when the plurality of demand time intervals include the demand time interval in which the predicted value exceeds the target value and the demand time intervals in each of which the predicted value does not exceed the target value, and operation contents each scheduled in the demand time interval in which the predicted value exceeds the target value include the operation content whose operation time is changeable, the changeable operation time of the operation content such that the operation content whose operation time is changeable is executed in any of the demand time intervals in each of which the predicted value does not exceed the target value, and a second unit arranged to control, when the operation time is not changed by the first unit, the predicted value for the current demand time interval does not exceed the target value, and the predicted value for the demand time interval subsequent to the current demand time interval exceeds the target value, at least one of the appliances which are continuously operated over both the current demand time interval and the subsequent demand time interval such that an effect of operating the appliance is higher in the current demand time interval than during a normal operation.

In the demand control device according to the third inventive aspect, the operation content whose operation time is changeable is, e.g., a defrosting operation of a showcase.

In the demand control device according to the third inventive aspect, the appliance which is continuously operated over the both demand time intervals is, e.g., a temperature adjusting appliance. In this case, when the predicted value in the current demand time interval does not exceed the target value, and the predicted value in the subsequent demand time interval exceeds the target value, the second unit changes a set temperature of the temperature adjusting appliance such that the effect of operating the appliance is higher in the current demand time interval than during a normal operation.

In the demand control device according to the third inventive aspect, the control unit may include a third unit arranged to select, when the predicted value calculated by the predicted value calculating unit for the current demand time interval exceeds the target value, any of the appliances whose operation should be halted based on a difference between the predicted value for the current demand time interval and the target value, and halt an operation of the selected appliance.

In the demand control device according to the third inventive aspect, the control unit may include the third unit arranged to select, when the predicted value calculated by the predicted value calculating unit for the current demand time interval exceeds the target value, any of the appliances whose operation should be halted based on the difference between the predicted value for the current demand time interval and the target value, and halt the selected appliance, and a fourth unit arranged to select, when the predicted value calculated by the predicted value calculating unit for the current demand time interval is not more than the target value, any of the appliances whose operation should be recovered based on the difference between the predicted value for the current demand time interval and the target value, and recover the operation of the selected appliance.

### BRIEF DESCRIPTION OF THE DRAWINGS

FIG. 1 is a block diagram showing power-consuming appliances provided in a store such as a supermarket, and a controller for centralized control of those appliances;

FIG. 2 is a schematic diagram for illustrating each environmental condition specified by a time zone and an outside air temperature;

FIG. 3 is a schematic diagram showing a part of the content of a power database 24;

FIG. 4 is a schematic diagram showing an example of the content of an operation state database 25;

FIG. 5 is a schematic diagram showing an example of the content of a halt/recovery table 26;

FIG. 6 is a flow chart showing the procedure of a demand control process executed by a controller 20 (CPU 21);

FIG. 7 is a flow chart showing the procedure of a prediction control process at the start of the demand time interval in step S5 of FIG. 6;

FIG. 8 is a flow chart showing a detailed procedure of a process in step S510 of FIG. 7;

FIG. 9 is a flow chart showing a detailed procedure of a process in step S520 of FIG. 7;

FIG. 10 is a flow chart showing the procedure of a prediction control process during the demand time interval in step S6 of FIG. 6; and

FIG. 11 is a flow chart showing a detailed procedure of a process in step 620 of FIG. 10.

### BEST MODE FOR CARRYING OUT THE INVENTION

Referring now to the drawings, an embodiment of the present invention will be described hereinbelow.

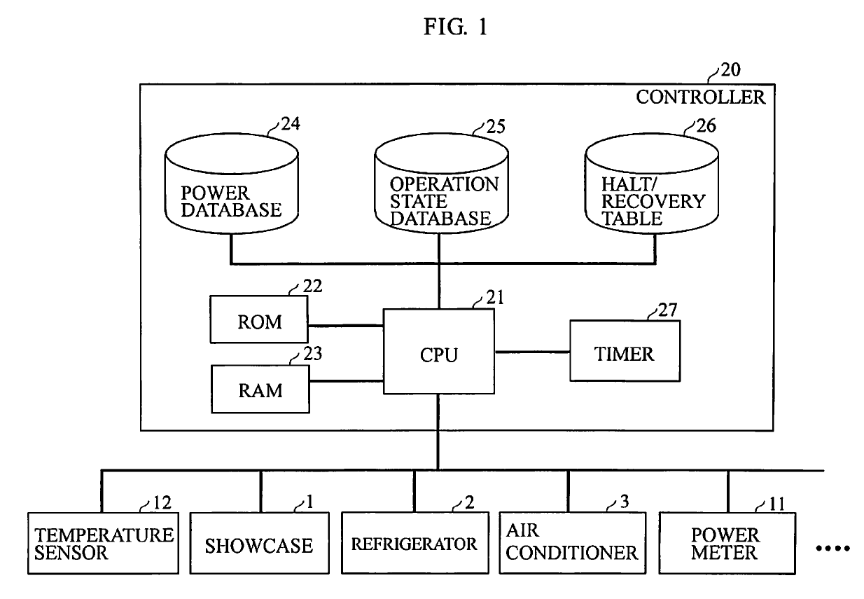

FIG. 1 shows power-consuming appliances provided in a store such as a supermarket, and a controller for centralized control of those appliances.

The controller 20 is connected to each of the power-consuming appliances arranged in the store, e.g., a showcase 1, a refrigerator 2, an air conditioner 3, and the like. The controller 20 is also connected to a power meter 11 which measures electronic power consumption. The controller 20 is further connected to a temperature sensor 12 for measuring an outside air temperature.

The controller 20 includes a CPU 21. The CPU 21 is connected to a ROM 22 which stores a program thereof or the like, a RAM 23 which stores necessary data, a power database 24, an operation state database 25, a halt/recovery table 26, a timer 27, and the like. The power database 24, the operation state database 25, and the halt/recovery table 26 are created in, e.g., a rewritable nonvolatile memory.

The power database 24 stores power consumption integrated value data (previous performance data) for each individual environmental condition. In this example, as shown in FIG. 2, the environmental condition is specified by a time zone and an outside air temperature. Each square in FIG. 2 shows an individual environmental condition. In the example of FIG. 2, the time zone and the outside air temperature are divided at intervals of 10 minutes and 5 degrees, respectively. The diagonally hatched square shown in FIG. 2 indicates the environmental condition where the time zone is from 0:30 to 0:40, and the outside air temperature is from 5° C. to 10° C. In FIG. 2, (N−1), N, and (N+1) represent demand time intervals.

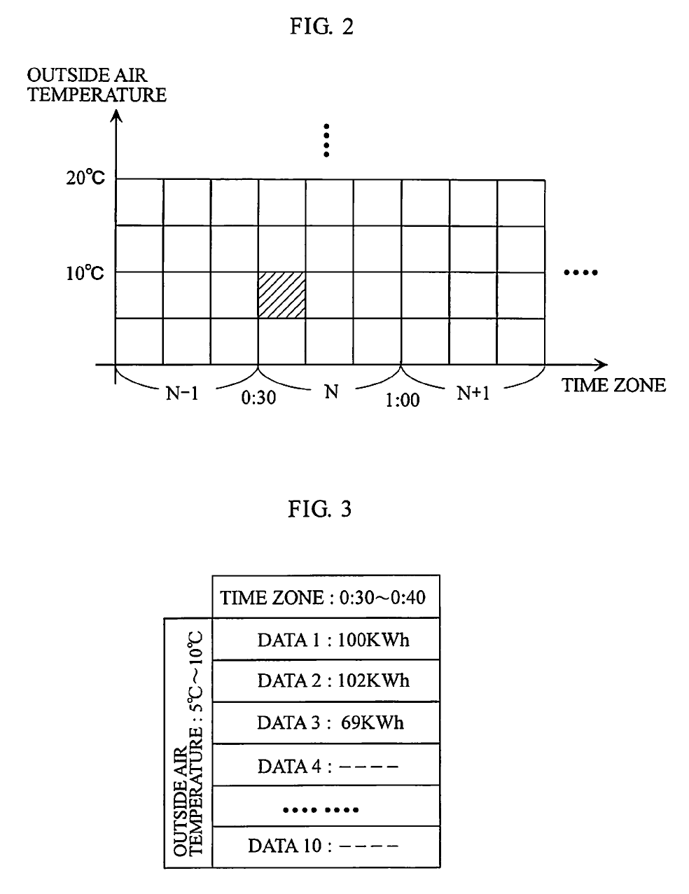

FIG. 3 shows a part of the content of the power database 24, which is the power consumption integrated value data stored in association with the environmental condition where the time zone is from 0:30 to 0:40, and the outside air temperature is from 5° C. to 10° C.

A maximum of ten performance data (power consumption integrated value data) can be stored for each individual environmental condition. When the number of performance data exceeds ten for one environmental condition, the oldest data is deleted, and the latest data is newly added.

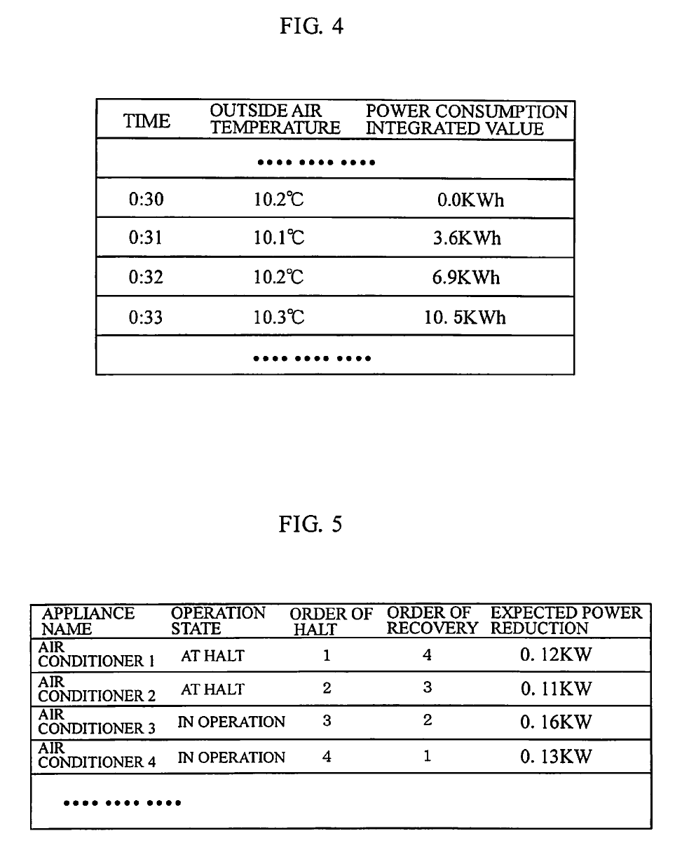

As shown in FIG. 4, the operation state database 25 stores an outside air temperature, and a power consumption integrated value from the start of a demand time interval up to the current time on a per time basis. At the start of the demand time interval, the power consumption integrated value is set to 0.

As shown in FIG. 5, the halt/recovery table 26 stores an appliance name, an operation state (in operation or at a halt), an order of halt, an order of recovery, and an expected power reduction for each one of haltable appliances.

The order of halt indicates a priority in halting the operation of an appliance. The order of recovery indicates a priority in activating an appliance at a halt. The expected power reduction indicates the electric power consumption expected to be reduced at the time when the operation of the appliance is halted. The expected power reduction is assumed to be, e.g., mean power consumption during immediately previous 30 minutes. Alternatively, when power measurement is not performed for each individual appliance, the expected power reduction may also be calculated from the rated power of an appliance. The expected power reduction is assumed to be, e.g., 50% of the rated power.

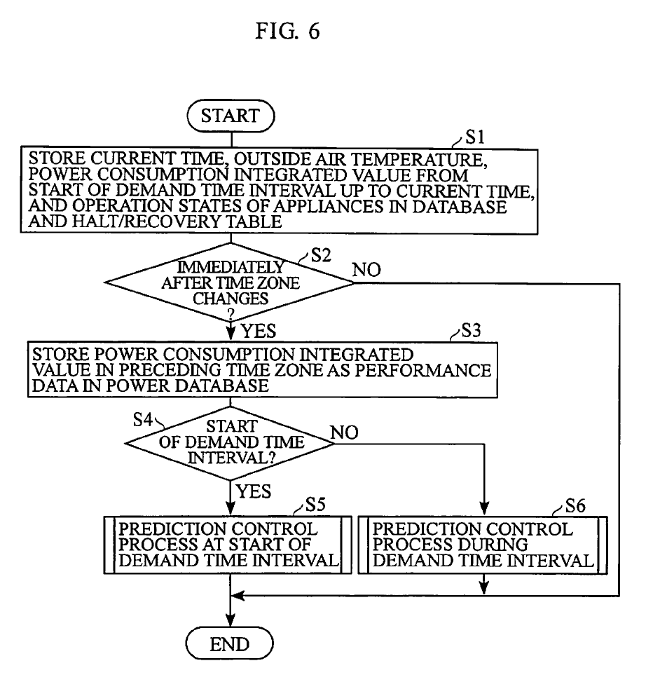

FIG. 6 shows the procedure of a demand control process executed by the controller 20 (CPU 21).

This process is executed every given period of time, e.g., every one minute.

First, a current time, an outside air temperature, and a power consumption integrated value from the start of a demand time interval up to the current time are stored in the operation state database 25, while the operation states of appliances are stored in the halt/recovery table 26 (step S1). The outside air temperature is acquired from the temperature sensor 12. The power consumption integrated value from the start of the demand time interval up to the current time is calculated based on the power consumption acquired from the power meter 11, and the power consumption integrated value stored in the operation state database 25.

Next, it is determined whether or not the time is immediately after the change of the time zone that specifies the environmental condition (step S2). Since the time zone is divided at intervals of 10 minutes, it is determined whether or not the time is immediately after M:00 (M is a natural number of 0 to 23), M:10, M:20, M:30, M:40, or M:50. When it is determined that the time is not immediately after the change of the time zone that specifies the environmental condition, the current process is ended.

In step S2 mentioned above, when it is determined that the time is immediately after the change of the time zone that specifies the environmental condition, the power consumption integrated value in the preceding time zone is stored in the power database 24 as the performance data for the environmental condition which coincides with the environmental condition in the preceding time zone (step S3). In this case, the power consumption integrated value data in the preceding time zone is obtained from the power consumption integrated value in the corresponding time zone stored in the operation state database 25. The outside air temperature is obtained by calculating the mean value of the outside air temperature data in the preceding time zone stored in the operation state database 25. After the process in step S3, the whole process flow advances to step S4.

In step S4, it is determined whether or not the time is when the demand time interval starts. When it is determined that the time is when the demand time interval starts, the prediction control process at the start of the demand time interval is performed (step S5). The details of the prediction control process at the start of the demand time interval will be described later. Then, the current process is ended.

In the step S4 mentioned above, when it is determined that the time is not when the demand time interval starts, the prediction control process during the demand time interval is performed (step S6). The details of the prediction control process during the demand time interval will be described later. Then, the current process is ended.

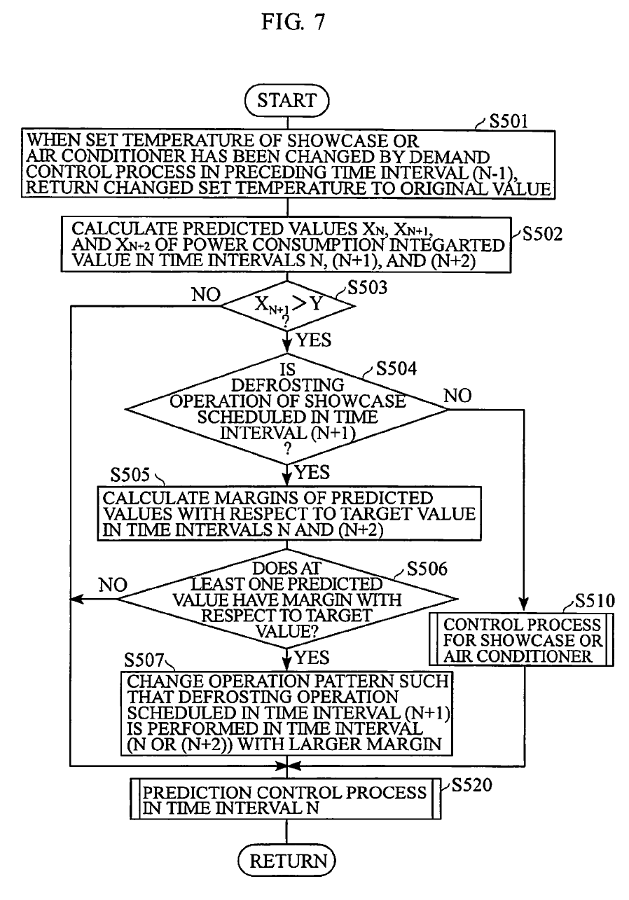

FIG. 7 shows the procedure of the prediction control process at the start of the demand time interval in step S5 of FIG. 6.

It is assumed that N represents the current demand time interval, (N−1), (N−2), . . . represent the time intervals previous thereto, and (N+1), (N+2), . . . represent the time intervals subsequent thereto. It is also assumed that a target value Y in the demand time interval has been predetermined. At the start of the demand time interval, the expected value of the power consumption integrated value is calculated for each one of the plurality of demand time intervals including the current demand time interval and the predetermined number of demand time intervals subsequent to the current demand time interval. In this embodiment, the predicted value of the power consumption integrated value is calculated for each one of the plurality of demand time intervals N, (N+1), and (N+2) including the current demand time interval and the two demand time intervals subsequent to the current demand time interval, as will be shown in step S502 described later. It is assumed in this embodiment that the showcase 1 and the air conditioner 3 are continuously operated over both the current demand time interval N and the subsequent demand time interval (N+1).

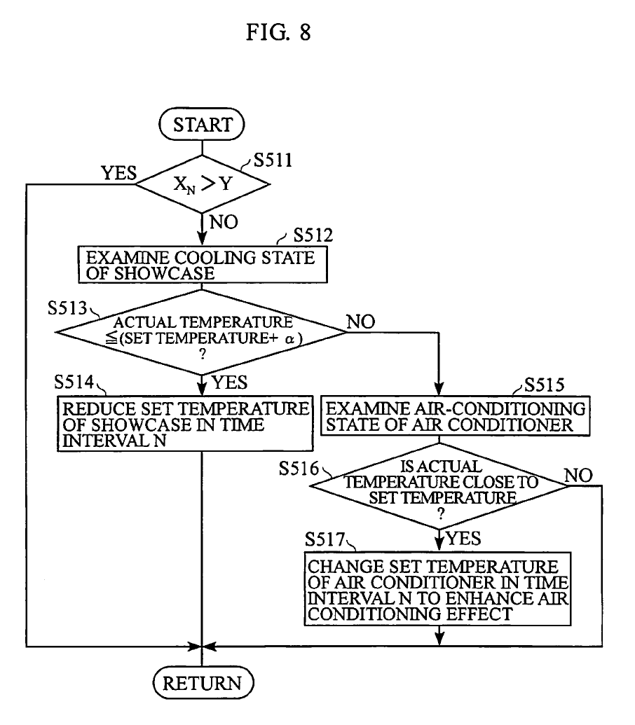

In the prediction control process at the start of the demand time interval, when the set temperature of the showcase or the air conditioner lo has been changed by the demand control process in the preceding time interval (N−1), the changed set temperature is returned to the original value (step S501). Specifically, when the set temperature of the showcase has been changed in step S514 (see FIG. 8) described later in the preceding time interval (N−1), or when the set temperature of the air conditioner has been changed in step S517 (see FIG. 8) described later in the preceding time interval (N−1), the settings are returned to the original ones.

Next, the power consumption integrated value in each of the time intervals N, (N+1), and (N+2) is predicted (step S502). For example, the predicted value of the power consumption integrated value in the time interval N is calculated as follows. That is, performance data corresponding to an environmental condition where the time zone is the first 10 minute time zone in the time interval N, and the outside air temperature coincides with the current outside air temperature is extracted from the power database 24, and a mean value xi of the performance data is calculated. In addition, performance data corresponding to an environmental condition where the time zone is an exactly middle 10 minute time zone in the time interval N, and the outside air temperature coincides with the current outside air temperature is extracted from the power database 24, and a mean value x2 of the performance data is calculated.

Further, performance data corresponding to an environmental condition where the time zone is the last 10 minute time zone in the time interval N, and the outside air temperature coincides with the current outside air temperature is extracted from the power database 24, and a mean value x3 of the performance data is calculated. Then, (x1+x2+x3) is calculated, and the result of the calculation is designated as a predicted value X_{N} of the power consumption integrated value in the time interval N.

Likewise, predicted values X_{N+1} and X_{N+2} of the respective power consumption integrated values in the time intervals (N+1) and (N+2) are also calculated.

Next, it is determined whether or not the predicted value X_{N+1} of the power consumption integrated value in the time interval (N+1) exceeds the target value Y (step S503). When X_{N+1}≦Y is satisfied, the process (prediction control process in the time interval N) in step S520 is performed, and then the current process is ended. The details of the process in step S520 will be described later.

When X_{N+1}>Y is satisfied, it is determined whether or not a defrosting operation of the showcase 1 is scheduled in the time interval (N+1) (step S504). When the defrosting operation of the showcase 1 is not scheduled, the process in step S510 (control process for the showcase or the air conditioner) is performed, and then the whole process flow moves to step S520. The details of the process in step S510 will be described later.

When the defrosting operation of the showcase 1 is scheduled, the margin of the predicted value X_{N} with respect to the target value Y in the time interval N, and the margin of the predicted value X_{N+2} with respect to the target value Y in the time interval (N+2) are calculated (step S505). Specifically, the margin in the time interval N is calculated based on Δ_{N}=(Y−X_{N}), and the margin in the time interval (N+2) is calculated based on Δ_{N+2}=(Y−X_{N+2}).

Then, it is determined whether or not at least one of the predicted values in the time interval N and the time interval (N+2) has a margin with respect to the target value (step S506). Specifically, it is determined whether or not at least one of Δ_{N} and Δ_{N+2} is more than 0. When at least one of Δ_{N} and Δ_{N+2} is more than 0, it is determined that at least one of the predicted values in the time interval N and the time interval (N+2) has a margin with respect to the target value. On the other hand, when each of Δ_{N} and Δ_{N+2} is not more than 0, it is determined that neither the predicted value in the time interval N nor the predicted value in the time interval (N+2) has a margin with respect to the target value.

When it is determined that at least one of the predicted values in the time interval N and the time interval (N+2) has a margin with respect to the target value, an operation pattern is changed such that the defrosting operation scheduled in the time interval (N+1) is performed in the time interval with a larger margin (step S507). Then, the whole process flow moves to step S520.

In the step S506 mentioned above, when it is determined that the power consumption has no margin in each of the time interval N and the time interval (N+2), the whole process flow moves to step S520.

FIG. 8 shows a detailed procedure of a process in step S510 of FIG. 7.

It is determined whether or not the predicted value X_{N} of the power consumption integrated value in the time interval N exceeds the target value Y (step S511). When X_{N}>Y is satisfied, the whole process flow moves to step S520 of FIG. 7.

When X_{N}≦Y is satisfied, the current cooling state of the showcase 1 is examined (step S512). That is, the set temperature of the showcase 1 and the actual temperature of the showcase 1 are examined. Then, it is determined whether or not the actual temperature of the showcase 1 is not more than a temperature obtained by adding a predetermined value a to the set temperature (step S513)

When the actual temperature of the showcase 1 is not more than the temperature obtained by adding the predetermined value a to the set temperature, it is determined that the showcase 1 is normally performing the cooling function, and the set temperature of the showcase 1 in the time interval N is reduced to a value lower than a normally set value (step S514). This is for achieving a reduction in power consumption integrated value in the time interval (N+1) by reducing the set temperature in the time interval N to extremely cool the showcase 1 till the internal temperature thereof reaches a value lower than the normally set value, and returning the set temperature to the original value at the start of the time interval (N+1). Then, the whole process flow moves to step S520 of FIG. 7.

When the actual temperature of the showcase 1 exceeds the temperature obtained by adding the predetermined value a to the set temperature, it is determined that the temperature of the showcase 1 cannot be effectively reduced even though the set temperature of the showcase 1 is reduced because of an air curtain which does not function due to a problem associated with a display condition, an air flow, or the like, and the whole process flow moves to step S515.

In step S515, the air conditioning state of the air conditioner 3 is examined. That is, the set temperature of the air conditioner 3 and the actual room temperature are examined. Then, it is determined whether or not the actual room temperature is close to the set temperature (step S516). Specifically, when the air conditioner 3 is performing a cooling operation, it is determined whether or not the actual room temperature is not more than a temperature obtained by adding a predetermined value B to the set temperature. When the actual room temperature is not more than the temperature obtained by adding the predetermined value 1 to the set temperature, it is determined that the actual room temperature is close to the set temperature. When the air conditioner 3 is performing a heating operation, it is determined whether or not the actual room temperature is not less than a temperature obtained by subtracting the predetermined value β from the set temperature. When the actual room temperature is not less than the temperature obtained by subtracting the predetermined value β from the set temperature, it is determined that the actual room temperature is close to the set temperature.

When it is determined that the actual room temperature is close to the set temperature, the set temperature of the air conditioner 3 is changed to enhance the air conditioning effect in the time interval N (step S517). That is, when the air conditioner 3 is performing a cooling operation, the set temperature is reduced to a value lower than a normally set value and, when the air conditioner 3 is performing a heating operation, the set temperature is increased to a value higher than a normally set value. Then, the whole process flow moves to step S520 of FIG. 7.

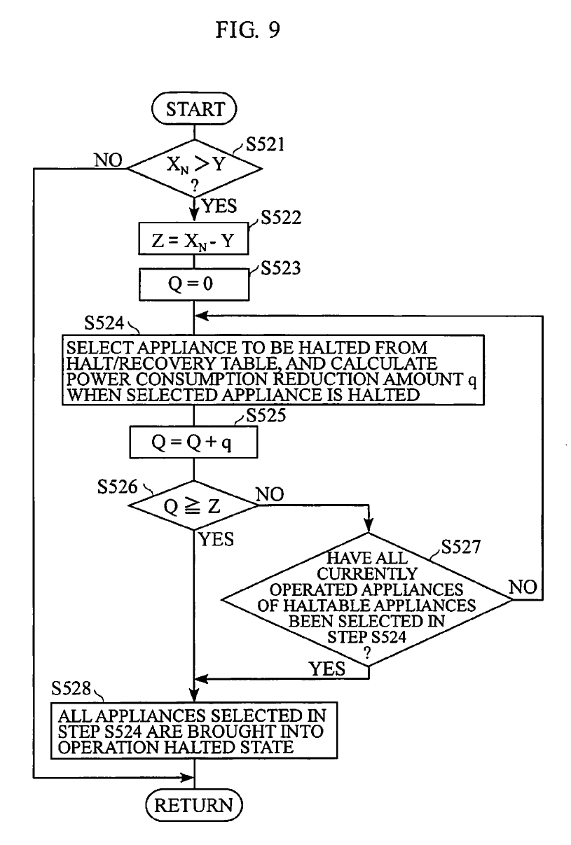

FIG. 9 shows a detailed procedure of a process in step S520 of FIG. 7.

It is determined whether or not the predicted value X_{N} of the power consumption integrated value in the time interval N exceeds the target value Y (X_{N}>Y) (step S521). When X_{N}≦Y is satisfied, the prediction control process at the start of the current demand time interval is ended.

When X_{N}>Y is satisfied, the difference Z=(X_{N}−Y) therebetween is calculated (step S522). The calculated difference Z serves as the amount of power consumption to be reduced (target reduction value). Additionally, a predicted reduction value Q of the power consumption is set to 0 (step S523).

Next, the appliance having the highest priority to be halted is selected from among the currently operated appliances in the halt/recovery table 26, and a power consumption reduction amount q at the time when the operation of the appliance is halted is also calculated (step S524). The power consumption reduction amount q can be obtained by multiplying the expected power reduction stored in the halt/recovery table 26 by the remaining period (which is 30 minutes in this example) of the demand time interval.

The power consumption reduction amount q calculated in step S524 is added to the predicted reduction value Q, and the result of the addition is designated as the predicted reduction value Q (step S525). Then, it is determined whether or not the predicted reduction value Q is not less than the target reduction value Z (Q≧Z) (step S526).

When the predicted reduction value Q is less than the target reduction value Z (Q<Z), it is determined whether or not all the currently operated appliances of the haltable appliances recorded in the halt/recovery table 26 have been each selected as a target appliance for which the power consumption reduction amount q is to be calculated (step S527).

When all the currently operated appliances of the haltable appliances recorded in the halt/recovery table 26 have not been each selected as the target appliance for which the power consumption reduction amount q is to be calculated, the whole process flow returns to step S524 where the appliance having the highest priority to be halted except for the appliances already selected in step S524 is selected, and the power consumption reduction amount q at the time when the operation of the selected appliance is halted is calculated. Then, the process in and subsequent to Step 525 is performed.

In the step S526 mentioned above, when it is determined that the predicted reduction value Q is not less than the target reduction value Z (Q≧Z), all the appliances selected in the step S524 mentioned above are brought into an operation halted state (step S528). Then, the prediction control process at the start of the current demand time interval is ended.

In the step S527 mentioned above, when it is determined that all the currently operated appliances of the haltable appliances recorded in the halt/recovery table 26 have been each selected as the target appliance for which the power consumption reduction amount q is to be calculated, all the appliances selected in the step S524 mentioned above are brought into the operation halted state (step S528). Then, the prediction control process at the start of the current demand time interval is ended.

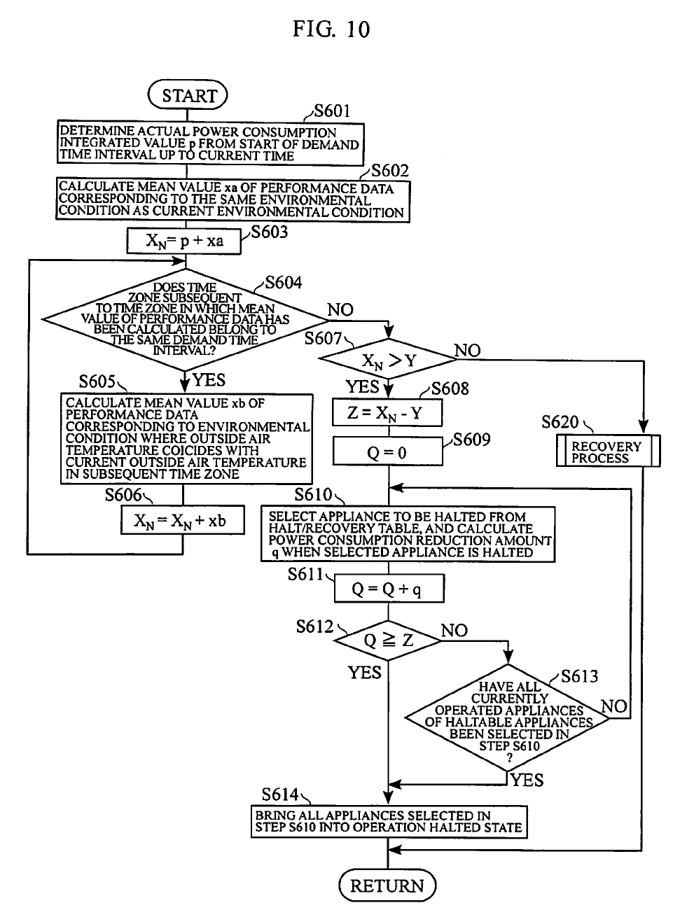

FIG. 10 shows the procedure of the prediction control process during the demand time interval in step S6 of FIG. 6.

In the prediction control process during the demand time interval, the actual power consumption integrated value from the start of the current time interval up to the current time is determined, and the predicted value of the power consumption integrated value from the current time up to the end of the demand time interval is also determined from the performance data stored for each individual environmental condition in the power database 24. The sum of the actual power consumption integrated value and the predicted value is designated as the predicted value X_{N} of the power consumption integrated value in the current demand time interval. Appliance control is performed based on the predicted value X_{N} and the predetermined target value Y

First, based on the data stored in the operation state database 25, an actual power consumption integrated value p from the start of the demand time interval up to the current time is determined (step S601).

Next, the performance data (power consumption integrated value data) corresponding to the same environmental condition as the current environmental condition (the time zone and the outside air temperature) is extracted from the power database 24, and the mean value of the performance data is calculated (step S602).

Then, the power consumption integrated value p determined in step S601 and the mean value xa calculated in step S602 are added up, and the result of the addition is designated as the predicted value X_{N} (step S603).

Next, it is determined whether or not the time zone subsequent to the time zone in which the mean value of the performance data is calculated belongs to the same demand time interval (step S604). When the time zone subsequent to the time zone in which the mean value of the performance data is calculated belongs to the same demand time interval, the performance data (power consumption integrated value data) corresponding to the environmental condition where the outside air temperature coincides with the current outside air temperature in the subsequent time zone is extracted from the power database 24, and the mean value xb of the performance data is calculated (step S605). Then, the mean value xb of the calculated performance data is added to the predicted value X_{N}, and the obtained result is designated as the predicted value X_{N} (step S606). Then, the whole process flow returns to step S604.

In the case where the time is immediately after a lapse of 10 minutes from the start of the demand time interval, the actual power consumption integrated value p from the start of the demand time interval up to the current time is calculated in step S601, the mean value xa of the performance data in the time zone from the time point after the lapse of 10 minutes from the start of the demand time interval till a lapse of 20 minutes therefrom is calculated in step S602, and the arithmetic operation of X_{N}=p+xa is performed in step S603. The first-time step S604 results in YES, the mean value xb of the performance data in the time zone from the time point after the lapse of 20 minutes from the start of the demand time interval till a lapse of 30 minutes therefrom is calculated in step S605, and the arithmetic operation of X_{N}=X_{N}+xb is performed in step S606. Then, the second-time step S604 results in NO.

In the case where the time is immediately after the lapse of 20 minutes from the start of the demand time interval, the actual power consumption integrated value p from the start of the demand time interval up to the current time is calculated in step S601, the mean value xa of the performance data in the time zone from the time point after the lapse of 20 minutes from the start of the demand time interval till the lapse of 30 minutes therefrom is calculated in step S602, and the arithmetic operation of X_{N}=p+xa is performed in step S603. The first-time step S604 results in NO.

In the step S604 mentioned above, when it is determined that the time zone subsequent to the time zone in which the mean value of the performance data is calculated does not belong to the same demand time interval, step S604 results in NO so that the whole process flow moves to Step S607.

In step S607, it is determined whether or not the predicted value X_{N} exceeds the predetermined target value Y (X_{N}>Y).

When X_{N}>Y is satisfied, the same process as performed in steps S522 to S528 of FIG. 9 is performed. That is, the difference Z=(X_{N}−Y) therebetween is calculated (step S608). The calculated difference Z serves as the amount of power consumption to be reduced (target reduction value). Additionally, the predicted reduction value Q of the power consumption is set to 0 (Step S609).

Next, the appliance having the highest priority to be halted is selected from among the currently operated appliances in the halt/recovery table 26, and the power consumption reduction amount q at the time when the operation of the selected appliance is halted is calculated (step S610). The power consumption reduction amount q can be obtained by multiplying the expected power reduction stored in the halt/recovery table 26 by the remaining period (which is either 20 minutes or 10 minutes in this example) of the demand time interval.

The power consumption reduction amount q calculated in step S610 is added to the predicted reduction value Q, and the result of the addition is designated as the predicted reduction value Q (step S611). Then, it is determined whether or not the predicted reduction value Q is not less than the target reduction value Z (Q≧Z) (step S612).

When the predicted reduction value Q is less than the target reduction value Z (Q<Z), it is determined whether or not all the currently operated appliances of the haltable appliances recorded in the halt/recovery table 26 have been each selected as the target appliance for which the power consumption reduction amount q is to be calculated (step S613).

When all the currently operated appliances of the haltable appliances recorded in the halt/recovery table 26 have not been each selected as the appliance for which the power consumption reduction amount q is to be calculated, the whole process flow returns to step S610 where the appliance having the highest priority of being halted is selected from among the currently operated appliances except for the appliance already selected in step S610, and the power consumption reduction amount q at the time when the operation of the selected appliance is halted is calculated. Then, the process in and subsequent to step S611 is performed.

In the step S612 mentioned above, when it is determined that the predicted reduction value Q is not less than the target reduction value Z (Q>Z), all the appliances selected in the step S610 mentioned above is brought into the operation halted state (Step S614). Then, the prediction control process during the current demand time interval is ended.

In the step S613 mentioned above, when it is determined that all the currently operated appliances of the haltable appliances recorded in the halt/recovery table 26 have been each selected as the target appliance for which the power consumption reduction amount q is to be calculated, all the appliances selected in the step S610 mentioned above are brought into the operation halted state (step S614). Then, the prediction control process during the current demand time interval is ended.

In the step S607 mentioned above, when X_{N}≦Y is satisfied, the recovery process is performed (S 620), and then the prediction control process during the current demand time interval is ended. The recovery process will be described later.

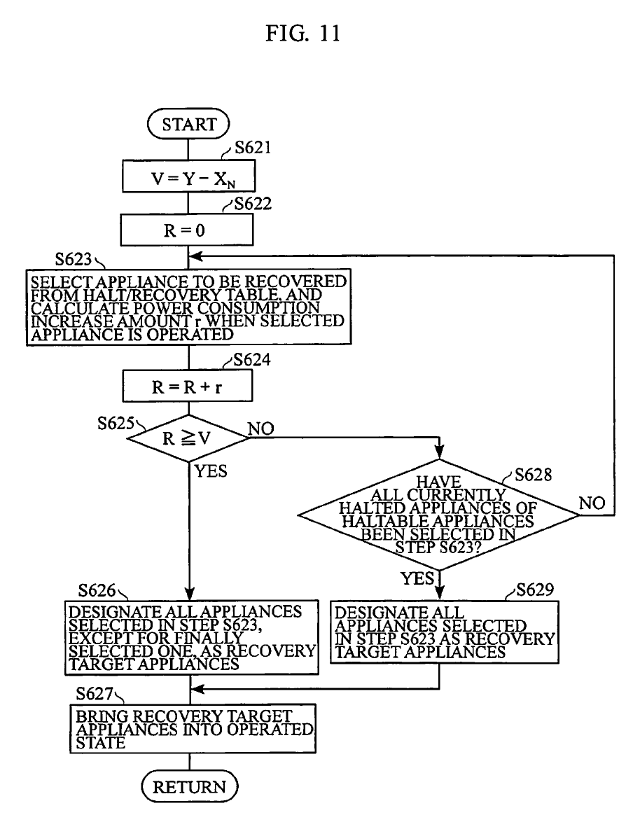

FIG. 11 shows a detailed procedure of a process in step S620 of FIG. 10.

In the recovery process, the difference V=(Y−X_{N}) between the target value Y and the predicted value X_{N} is calculated (step S621). The calculated difference V serves as the amount of power consumption to be recovered (target recovery value). Additionally, a target recovery value R of the power consumption is set to 0 (step S622).

Next, the appliance having the highest priority to be recovered is selected from among the currently halted appliances in the halt/recovery table 26, and a power consumption increase amount r at the time when the selected appliance is operated is calculated (step S623). The power consumption increase value r can be obtained by multiplying the expected power reduction stored in the halt/recovery table 26 by the remaining period (which is either 20 minutes or 10 minutes in this example) of the demand time interval.

The power consumption increase amount r calculated in step S623 is added to the predicted recovery value R, and the result of the addition is designated as the predicted recovery value R (step S624). Then, it is determined whether or not the predicted recovery value R is not less than the target recovery value V (R≧V) (step S625).

When the predicted recovery value R is less than the target recovery value (R<V), it is determined whether or not all the currently halted appliances of the haltable appliances recorded in the halt/recovery table 26 have been each selected as the target appliance for which the power consumption increase amount r is to be calculated (step S628).

When all the currently halted appliances of the haltable appliances recorded in the halt/recovery table 26 have not been each selected as the target appliance for which the power consumption increase amount r is to be calculated, the whole process flow returns to step S623 where the appliance having the highest priority to be recovered is selected from among the currently halted appliances except for the appliance already selected in step S623, and the power consumption increase amount r at the time when the selected appliance is operated is calculated. Then, the process in and subsequent to S624 is performed.

In the step S625 mentioned above, when it is determined that the predicted recovery value R is not less than the target recovery value V (R≧V), all the appliances selected in the step S623 mentioned above, except for the finally selected one, are each designated as the recovery target appliance (step S626). Then, the whole process flow moves to step S627.

In the step S628 mentioned above, when it is determined that all the currently halted appliances of the haltable appliances recorded in the halt/recovery table 26 have been each selected as the target appliance for which the power consumption increase amount r is to be calculated, all the appliances selected in the step S623 mentioned above are each designated as the recovery target appliance (step S629). Then, the whole process flow moves to step S627.

In step S627, the recovery target appliance is brought into an operated state. Then, the prediction control process during the current demand time interval is ended.

In the embodiment described above, the environmental condition is specified by the time zone and the outside air temperature. However, the environmental condition may also be specified by other elements, e.g., the time zone and a temperature (or humidity) inside a store.

According to the embodiment described above, the predicted value of the power consumption integrated value is calculated for each one of the plurality of demand time intervals including the current demand time interval and the predetermined number of demand time intervals subsequent to the current demand time interval and, when the predicted value exceeds the target value in any of the demand time intervals, another demand time interval in which the predicted value has a margin is effectively used to allow a reduction in power consumption integrated value in the demand time interval in which the predicted value exceeds the target value.

Specifically, in the case where an operation content whose operation time is changeable, such as a defrosting operation, exists in the subsequent demand time interval in which the target value is exceeded, the changeable operation time of the operation content is changed such that the operation content whose operation time is changeable is executed in another demand time interval in which the predicted value has a margin. In the case where the predicted value has a margin in the demand time interval immediately preceding the demand time interval in which the target value is exceeded, subsequent to the current demand time interval, operation control is performed with respect to an appliance such as a showcase or an air conditioner such that the effect of operating the appliance is higher in the immediately preceding demand time interval than during a normal operation.

In accordance with the present invention, the predicted value of the power consumption integrated value is calculated for each one of a plurality of demand time intervals including a current demand time interval and a predetermined number of demand time intervals subsequent to the current demand time interval and, when the predicted value exceeds the target value in any of the demand time intervals, another demand time interval in which the predicted value has a margin is effectively used to allow a reduction in power consumption integrated value in the demand time interval in which the predicted value exceeds the target value, subsequent to the current demand time interval.

1. A demand control device applied in a facility provided with a plurality of power-consuming appliances, the demand control device comprising:
a unit arranged to store performance data of a power consumption integrated value for each individual environmental condition in a power database;
a predicted value calculating unit arranged to calculate a predicted value of the power consumption integrated value for each one of a plurality of demand time intervals including a current demand time interval and a predetermined number of demand time intervals subsequent to the current demand time interval based on the performance data stored in the power database at a start of the demand time interval; and
a control unit arranged to control the appliances based on the predicted value calculated by the predicted value calculating unit for each one of the plurality of demand time intervals and on a pre-set target value, wherein the control unit comprises:
a unit arranged to change, when the plurality of demand time intervals include the demand time interval in which the predicted value exceeds the target value and the demand time intervals in each of which the predicted value does not exceed the target value, and operation contents each scheduled in the demand time interval in which the predicted value exceeds the target value include the operation content whose operation time is changeable, the changeable operation time of the operation content such that the operation content whose operation time is changeable is executed in any of the demand time intervals in each of which the predicted value does not exceed the target value.

2. The demand control device according to claim 1, wherein the operation content whose operation time is changeable is a defrosting operation of a showcase.

3. The demand control device according to [either] claim 1, wherein the control unit comprises:
a unit arranged to select, when the predicted value calculated by the predicted value calculating unit for the current demand time interval exceeds the target value, any of the appliances whose operation should be halted based on a difference between the predicted value for the current demand time interval and the target value, and halt the operation of the selected appliance.

4. The demand control device according to [either] claim 1, herein the control unit comprises:
a unit arranged to select, when the predicted value calculated by the predicted value calculating unit for the current demand time interval exceeds the target value, any of the appliances which should be halted based on a difference between the predicted value for the current demand time interval and the target value, and halt the selected appliance; and
a unit arranged to select, when the predicted value calculated by the predicted value calculating unit for the current demand time interval is not more than the target value, any of the appliances whose operation should be recovered based on the difference between the predicted value for the current demand time interval and the target value, and recover the operation of the selected appliance.

5. A demand control device applied in a facility provided with a plurality of power-consuming appliances, the demand control device comprising:
a unit arranged to store performance data of a power consumption integrated value for each individual environmental condition in a power database;
a predicted value calculating unit arranged to calculate a predicted value of the power consumption integrated value for each one of a current demand time interval and a demand time interval subsequent to the current demand time interval based on the performance data stored in the power database at a start of the demand time interval; and
a control unit arranged to control the appliances based on the predicted value calculated by the predicted value calculating unit for each one of the plurality of demand time intervals and on a pre-set target value, wherein the control unit comprises:
a unit arranged to control, when the predicted value for the current demand time interval does not exceed the target value, and the predicted value for the subsequent demand time interval exceeds the target value, an operation of at least one of the appliances which are continuously operated over the both demand time intervals such that an effect of operating the appliance is higher in the current demand time interval than during a normal operation.

6. The demand control device according to claim 5, wherein the appliance which is continuously operated over the both demand time intervals is a temperature adjusting appliance and, when the predicted value for the current demand time interval does not exceed the target value, and the predicted value for the subsequent demand time interval exceeds the target value, the control unit changes a set temperature of the temperature adjusting appliance such that an effect of operating the appliance is higher in the current demand time interval than during a normal operation.

7. The demand control device according to [either] claim 5, wherein the control unit comprises:
a unit arranged to select, when the predicted value calculated by the predicted value calculating unit for the current demand time interval exceeds the target value, any of the appliances whose operation should be halted based on a difference between the predicted value for the current demand time interval and the target value, and halt the operation of the selected appliance.

8. The demand control device according to [either] claim 5, wherein the control unit comprises:
a unit arranged to select, when the predicted value calculated by the predicted value calculating unit for the current demand time interval exceeds the target value, any of the appliances which should be halted based on a difference between the predicted value for the current demand time interval and the target value, and halt the selected appliance; and
a unit arranged to select, when the predicted value calculated by the predicted value calculating unit for the current demand time interval is not more than the target value, any of the appliances whose operation should be recovered based on the difference between the predicted value for the current demand time interval and the target value, and recover the operation of the selected appliance.

9. A demand control device applied in a facility provided with a plurality of power-consuming appliances, the demand control device comprising:
a unit arranged to store performance data of a power consumption integrated value for each individual environmental condition in a power database;
a predicted value calculating unit arranged to calculate a predicted value of the power consumption integrated value for each one of a plurality of demand time intervals including a current demand time interval and a predetermined number of demand time intervals subsequent to the current demand time interval based on the performance data stored in the power database at a start of the demand time interval; and
a control unit arranged to control the appliances based on the predicted value calculated by the predicted value calculating unit for each one of the plurality of demand time intervals and on a pre-set target value, wherein the control unit comprises:
a first unit arranged to change, when the plurality of demand time intervals include the demand time interval in which the predicted value exceeds the target value and the demand time intervals in each of which the predicted value does not exceed the target value, and operation contents each scheduled in the demand time interval in which the predicted value exceeds the target value include the operation content whose operation time is changeable, the changeable operation time of the operation content such that the operation content whose operation time is changeable is executed in any of the demand time intervals in each of which the predicted value does not exceed the target value; and
a second unit arranged to control, when the operation time is not changed by the first unit, the predicted value for the current demand time interval does not exceed the target value, and the predicted value for the demand time interval subsequent to the current demand time interval exceeds the target value, at least one of the appliances which are continuously operated over both the current demand time interval and the subsequent demand time interval such that an effect of operating the appliance is higher in the current demand time interval than during a normal operation.
